(19) United States
(12) Patent Application Publication
(10) Pub. No.: US 2026/0039386 A1
(43) Pub. Date: Feb. 5, 2026

(54) AUTO-TUNABLE OPTICAL TRANSCEIVERS

(71) Applicant: Charter Communications Operating, LLC, St. Louis, MO (US)

(72) Inventor: Marek Hajduczenia, Castle Rock, CO (US)

(73) Assignee: Charter Communications Operating, LLC, St. Louis, MO (US)

(21) Appl. No.: 18/793,223

(22) Filed: Aug. 2, 2024

(51) Int. Cl. H04B 10/40

(52) U.S. Cl. CPC H04B 10/40

(57) ABSTRACT

A (first) auto-tunable, optical transceiver that transmits outgoing Channel Information Messages (CIMs) using a plurality of local channels, each outgoing CIM message identifying (i) the local channel used to transmit the outgoing CIM message and (i) a remote-channel value usable to identify a remote channel used by a (second) auto-tunable, optical transceiver to transmit a CIM message to the first transceiver over an optical link, until the first transceiver receives an incoming CIM message from the second transceiver that indicates that the second transceiver received an outgoing CIM message from the first transceiver in a target local channel. The first transceiver can then transmit data to the second transceiver using the target local channel. The second transceiver operates likewise, thereby enabling the first and second transceivers to auto-tune to appropriate target channels without requiring manual intervention.

### BACKGROUND

### Field of the Disclosure

The present disclosure relates to communications and, more specifically but not exclusively, to tunable optical transceivers.

### Description of the Related Art

This section introduces aspects that may help facilitate a better understanding of the disclosure. Accordingly, the statements of this section are to be read in this light and are not to be understood as admissions about what is prior art or what is not prior art.

Fixed, Dense Wavelength Division Multiplexing (DWDM) transceivers are both cost and power efficient, and have been in broad use in various telecom areas. One of their primary challenges, though, is that a different variant for each wavelength used is required, resulting in colored transceiver modules, suitable only for the specific target wavelength (color). For a typical 40-channel DWDM system, that implies having to stock 40 different transceiver modules, keeping track of them, and also making sure that the installers are capable of deploying appropriate modules attached to the specific WDM filter port. This is usually error prone, resulting in multiple truck rolls to remote locations, caused by poor information flow, poor labeling policies, or even fiber management. Additionally, it requires each and every field technician to have spares for each and every transceiver on their truck, resulting in massive inventory management problems, especially when transceivers are found to be defective and/or need to be replaced.

This problem is partially solved through the utilization of tunable optical transceivers, where the units can be manually field coded to the specific wavelength channel with an external device, reducing the number of transceiver variants the field techs needed to have with them on the truck. In some cases, the tuning can be performed in the target device, without the need for external coders, eliminating the need for extra tuning hardware, but still requiring manual on-site coding. The manual on-site coding approach does not eliminate any issues associated with the information flow, poor labeling policies, or even fiber management, resulting in the need for trucks rolls when something does not get configured correctly.

Both of these methods (fixed wavelength transceivers and on-site manually tunable transceivers) are also unable to dynamically adapt to changes in the WDM filtering design, where transmit/receive channels used for the given customer site need to be moved over to another set due to field work, channel grooming, fiber splicing, etc. In such cases, every single change to WDM filter port(s) allocation results in expensive truck rolls to replace or re-code individual transceivers at the customer site.

### SUMMARY

Problems in the prior art are addressed in accordance with the principles of the present disclosure by an optical transceiver that performs an auto-tuning operation, discovering dynamically its local operating channel depending on the WDM filter port it is connected to, by communicating with a remote, auto-tuning optical transceiver at the other end of the WDM link. This proposed approach applies to Coarse WDM (CWDM) and DWDM systems alike, as long as both ends of the optical link match in terms of WDM channel count. Each optical transceiver supports the auto-tuning operation, announcing its channel support to ensure interoperability between devices from different vendors.

The proposed approach allows a field technician to simply plug in the auto-tunable transceiver, connect it to the WDM filter and the connected fiber drop, and allow the transceiver to perform its auto-tuning operation. This approach also enables a drop-ship deployment model, where the customer equipment is shipped to the destination address with the auto-tunable optics plugged in, to be connected to the fiber by the customer themselves, without the assistance of the operator field tech. Once the auto-tuning operation is completed and the optical link has been established, the logical-layer configuration can proceed, including, e.g., dynamic address assignment via DHCPv4/DHCPv6, following by zero-touch provisioning and/or manual configuration steps required to bring the device fully online and operational. This eliminates sources of deployment error, as well as allowing for dynamic changes to WDM filter port allocation without the need for a truck roll to each customer site. A loss-of-signal (LOS) condition for a certain amount of time is sufficient to trigger the auto-tuning operation, allowing the transceiver to re-detect the appropriate channel and complete the optical link lock. The storage of the last tuned-channel information allows the transceiver to re-start at the last known good setting, speeding up link recovery when there are no changes to the WDM link design.

The proposed approach applies to any single- or multi-wavelength channel-tunable optical transceiver, including SFP, SFP+, XFP, QSFP, QSFP28, and other standard formats. In the case of multi-channel tunable transceivers, each channel is operated independently and following the same auto-tuning process.

In at least one embodiment of the present disclosure, a first, auto-tunable, optical transceiver that transmits outgoing Channel Information Messages (CIMs) using a plurality of local channels, each outgoing CIM message identifying (i) the local channel used to transmit the outgoing CIM message and (i) a remote-channel value usable to identify a remote channel used by a second, auto-tunable, optical transceiver to transmit a CIM message to the first transceiver over an optical link, until the first transceiver receives an incoming CIM message from the second transceiver that indicates that the second transceiver received an outgoing CIM message from the first transceiver in a target local channel. The first transceiver transmits data to the second transceiver using the target local channel.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a communication network according to certain embodiments of the disclosure;

FIG. 2 is a simplified block diagram of the communication network of FIG. 1;

FIG. 3 is a state diagram representing the receive state machine executed by the local receive process of FIGS. 1 and 2, according to certain embodiments of the disclosure;

FIG. 4 is a state diagram representing the transmit state machine executed by the local transmit process of FIGS. 1 and 2, according to certain embodiments of the disclosure;

FIG. 5 is a diagram representing the format of a CIM message, according to certain embodiments of the disclosure;

FIG. 6 is a timing diagram illustrating typical connection timing for the network of FIGS. 1 and 2;

FIG. 7 is a timing diagram illustrating an example data exchange between the first and second transceivers of FIGS. 1 and 2; and

FIG. 8 is a simplified hardware block diagram of an example node that can be used to implement either of the first and second optical transceivers of FIGS. 1 and 2.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

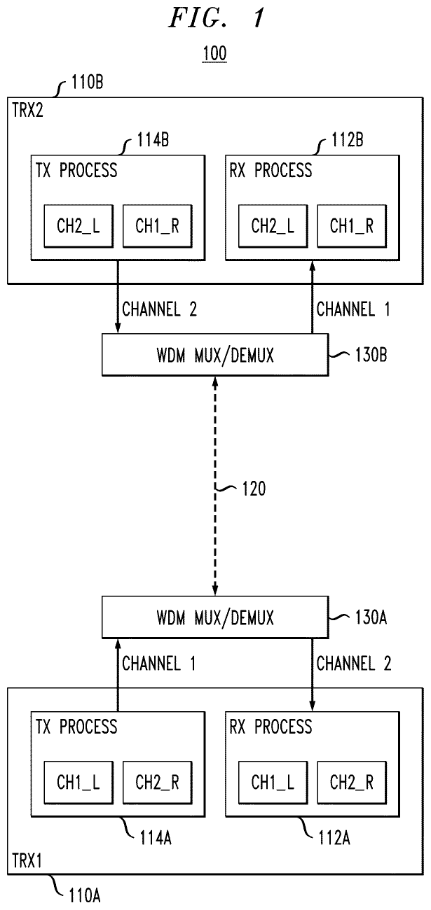

FIG. 1 is a block diagram of a communication network 100 according to certain embodiments of the disclosure. The communication network 100 comprises first and second auto-tunable optical transceivers (TRXs) 110A and 110B that are (i) part of respective host devices (not shown) and (ii) interconnected by a multi-channel WDM optical link 120 (having one or more optical fibers), where the first transceiver 110A is automatically tuned to transmit optical signals over the optical link 120 to the remote transceiver 110B using a first channel (CH1) and the second transceiver 110B is automatically tuned to transmit optical signals over the optical link 120 to the local transceiver 110A using a second channel (CH2).

Located at one end of the optical link 120 is a first WDM mux/demux AD1, which forwards (i) outgoing transmitted signals in the first channel CH1 from the first transceiver 110A to the optical link 120 and (ii) incoming received signals in the second channel CH2 from the optical link 120 to the first transceiver 110A. Likewise, located at the other end of the optical link 120 is a second WDM mux/demux AD2, which forwards (i) outgoing transmitted signals in the second channel CH2 from the second transceiver 110B to the optical link 120 and (ii) incoming received signals in the first channel CH1 from the optical link 120 to the second transceiver 110B. Depending on the filtering performed by WDM optical filters (not shown) in the optical link 120, the first and second channels CH1 and CH2 may be the same channel or two different channels of the available channels supported by the two transceivers 110A and 110B.

Note that each transceiver 110 operates as a broadband receiver capable of processing any received signals in any of its supported wavelength channels. Note further that, when initially powered on, each transceiver 110 is not aware of the optical filtering performed by the optical link 120, which may limit the wavelength channels the transceiver can use to transmit signals to the other transceiver.

As shown in FIG. 1, each transceiver 110 performs a similar receive (RX) process 112 and a similar transmit (TX) process 114 to determine and keep track of the first and second channels CH1 and CH2. As represented in FIG. 1, the first transceiver 110A performs the first RX process 112A and the first TX process 114A to keep track of the first channel CH1 using variable CH1_L and the second channel CH2 using variable CH2_R, while the second transceiver 110B performs the second RX process 112B and the second TX process 114B to keep track of the first channel CH1 using variable CH1_R and the second channel CH2 using variable CH2_L.

Note that “L” stands for “local” and “R” stands for “remote”. For the first transceiver 110A, the first transceiver 110A is the local transceiver, while the second transceiver 110B is the remote transceiver, and vice versa for the second transceiver 110B.

After the two transceivers 110A and 110B are plugged into their respective host devices and powered on, in parallel, each transceiver 110 starts automatically transmitting on one of its supported wavelength channels, going through the supported wavelength channel grid in a specific pattern. Typically, the wavelength channels can be searched through in an incrementing, decrementing, or any random/pre-defined order, without affecting the interoperability between transceivers 110 from other vendors. It is possible for the transceivers 110 on both ends to use different search patterns without any issues. The WDM filters in the optical link 120 block any transmitted wavelength that does not match with the filter port, filtering any channels outside of the target one.

The search process continues until the first transceiver 110A receives confirmation from the second transceiver 110B that the first channel CH1 has been successfully established, and vice versa for the second channel CH2. The first and second transceivers 110A and 110B complete the handshake and lock to their correct wavelengths, and normal data transmission can then begin.

Note that, in a typical scenario, one of the two transceivers will be plugged into its host device and powered up before the other transceiver is plugged into its host device and powered up. In that case, the initial transceiver 110 will start its auto-tuning processing and continue to cycle through its available channels until the latter transceiver 110 is plugged in and powered up, at which point, the latter transceiver 110 will begin its auto-tuning processing, thereby enabling both transceivers 110 to make progress in their parallel auto-tuning processing.

Once the confirmation has been received, each transceiver 110 saves the channel information for future use. After an equipment reboot or a power failure, each transceiver 110 automatically starts with the last-known correct channel to minimize the lock time. If and when a WDM filter port move occurs, each transceiver 110 automatically restarts its scanning process after detecting a loss of signal. In either of these cases, there is no need for any manual intervention, thereby not requiring a truck roll.

Each transceiver 110, when plugged into any host device and after the auto-tuning processing has completed, is recognized as a tunable device, operating on a specific wavelength channel corresponding to the wavelength channel that was locked onto during its auto-tuning processing.

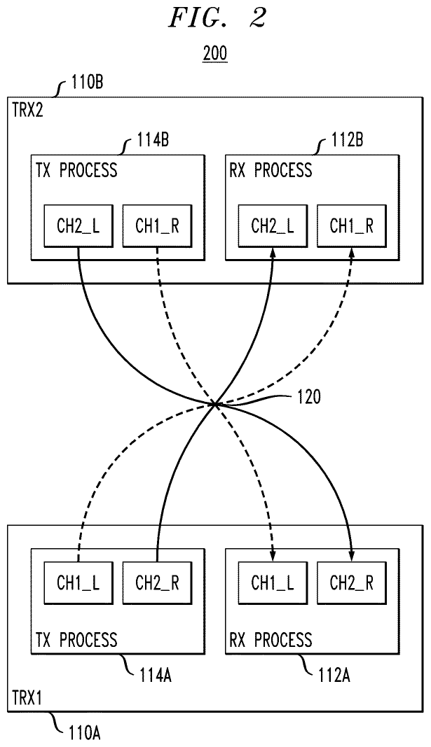

FIG. 2 is a simplified block diagram of the communication network 100 of FIG. 1 representing the exchange of channel information between the first and second transceivers 110A and 110B over the optical link 120 during the parallel auto-tuning processing performed by those transceivers.

Using the first TX process 114A, the first transceiver 110A transmits its current first-channel information (CH1_L) and re-transmits the second-channel information (CH2_R), once that second-channel information has been received from the second transceiver 110B. When no second-channel information has been yet received from the second transceiver 110B, the first transceiver 110A transmits CH2_R with the value of, for example, “0”, indicating an unselected/unknown channel.

Using the similar second TX process 114B, the second transceiver 110B transmits its current second-channel information (CH2_L) and re-transmits the first-channel information (CH1_R), once that first-channel information has been received from the first transceiver 110A. Similarly, when no first-channel information has been yet received from the first transceiver 110A, the second transceiver 110B transmits CH1_R with the value of, for example, “0”, indicating an unselected/unknown channel.

The second transmit process 114B in the second transceiver 110B transmits channel information messages (CIMs) containing (i) the re-transmitted first-channel information (CH1_L), if available, and (ii) transmitted second-channel information (CH2_R), where CIM message is transmitted in the currently selected CH2_R channel. The first receive process 112A in the first transceiver 110A will receive a CIM message only when the second transceiver 110B tunes to a target wavelength channel that is transmitted properly across the WDM-filtered optical link 120. All other channels different from the target channel are filtered out within the WDM-filtered optical link 120. The first transceiver 110A locally stores the received second-channel information (CH2_R). The re-transmitted first-channel information (CH1_L) is received only when the first transceiver 110A is able to reach the second transceiver 110B and deliver the first transceiver 110A's channel information. When the received CH1_L represents an unselected, unknown channel (e.g., CH1_L=0), the first transceiver 110A has not yet successfully communicated with the second transceiver 110B and the auto-tuning process must continue. When the received CH1_L represents a selected, known channel (e.g., CH1_L!=0), the first transceiver 110A has successfully established communication with the second transceiver 110B and the appropriate wavelength channel for the first transceiver 110A was found and can be stored.

The same receive process 112B operates in parallel in the second transceiver 110B using the very same logic but operating on the local channel (CH2_L) and remote channel (CH1_R) information.

### Receive State Machine

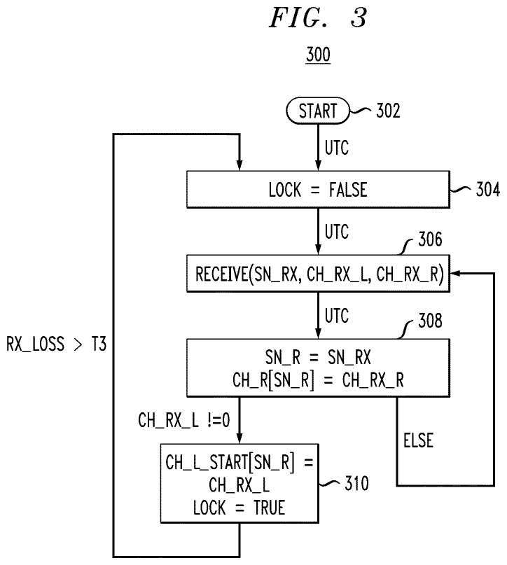

FIG. 3 is a state diagram representing the receive state machine 300 executed by the local receive process 112 and performed independently by each of the transceivers 110 of FIGS. 1 and 2, according to certain embodiments of the disclosure. The receive state machine 300, which follows the IEEE 802.3 standard conventions for state diagrams and employs C/C++ style assignment and comparison operands, uses the following variables:
CH_RX_L: Received local channel number, re-transmitted by the remote transceiver;
CH_RX_R: Received remote channel number, transmitted by the remote transceiver;
SN_RX: Received serial number, transmitted by the remote transceiver;
CH_R: Remote channel number, stored locally in non-volatile memory;
CH_L_start: Local start channel number, stored locally in non-volatile memory;
SN_R: Serial number of the remote transceiver, stored locally in non-volatile memory. If populated (e.g., a non-empty value was received), then the local transceiver may store serial-number-specific information, if the function is implemented. Any serial-number-specific information is indexed with [SN] symbol;
lock: A Boolean flag indicating whether the remote transceiver is in a locked state. This variable is set to true only when remote channel information was received and the local channel information was re-transmitted successfully by the remote transceiver; otherwise, set to false;
RX_LOSS: The duration of time a receive-signal loss remains asserted. If and when the RX_LOSS exceeds the value of T3, a link-loss event is detected, and the auto-tuning processing is required to restart. The T3 variable defines the duration of time that the local transceiver's loss of received signal moves the local transceiver from the locked state into an unlocked state and restarts the receive and transmit processes 112 and 114 in the local transceiver. A typical T3 value is preferably large enough to prevent rapid transition between the locked and unlocked state. For example, T3 may be between 60 second and 180 seconds; and
“UTC” stands for “UnConditional Transition” and represents an unconditional transition between two different states in the state diagrams, when no transition conditions apply.

Note that, when the local transceiver 110 is a multi-channel transceiver, it may be connected to multiple different remote transceivers. In that case, CH_R will be an array of remote channel numbers and CH_L_start will be an array of local channel numbers, both distinguished by the unique serial numbers SN_R of the different remote transceivers.

Referring to FIG. 3, when the local transceiver 110 is powered on, the receive state machine 300 transitions from the start state 302 to state 304, where lock is set to false, indicating that the local transmit channel has not been determined yet. The receive state machine 300 then transitions to state 306. The receive state 306 is a blocking function, i.e., the transceiver remains in state 306 until a properly formatted CIM message, contains the variables SN_RX, CH_RX_L, and CH_RX_R, has been received. A possible CIM structure is defined further below.

After receiving such a CIM message, the receive state machine 300 then transitions to state 308, where SN_R is set equal to SN_RX and CH_R [SN_R] is set equal to CH_RX_R.

If CH_RX_L is not equal to zero, indicating that the remote transceiver has successfully received the CIM message transmitted by the local transceiver using the currently selected local transmit channel, then the receive state machine 300 transitions to state 310, where CH_L_start is set equal to CH_RX_L and lock is set equal to true. The receive state machine 300 remains in state 310 until RX_LOSS exceeds T3, indicating detecting of a link-loss event, in which case, the receive state machine 300 transitions back to state 304 to re-start the receive process 112.

Referring again to state 308, if CH_RX equals zero, indicating that the remote transceiver has not yet successfully received signals transmitted by the local transceiver, then the receive state machine 300 transitions back to state 306 to await the receipt of another CIM message from the remote transceiver.

### Transmit State Machine

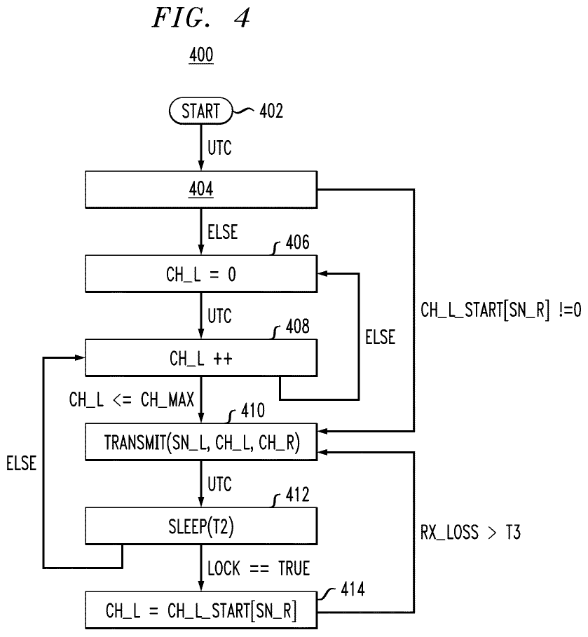

FIG. 4 is a state diagram representing the transmit state machine 400 executed by the local transmit process 114 performed independently by each of the transceivers 110 of FIGS. 1 and 2, according to certain embodiments of the disclosure. The local transmit process 114 operates independently from the local receive process 112, but some of the variables are shared between the transmit and receive state diagrams for proper communication and state synchronization. In addition to any variables used by the receive state machine 300 of FIG. 3, the transmit state machine 400, which also follows the IEEE 802.3 standard conventions for state diagrams and employs C/C++ style assignment and comparison operands, also uses the following variables, which may also be shared with the receive state machine 300:
CH_L: Local channel number, currently tuned to for transmission as part of the auto-tuning processing;
CH_max: The number of wavelength channels supported by the local transceiver; and
SN_L: The serial number of the local transceiver.

Referring to FIG. 4, when the local transceiver 110 is powered on, either initially or after a link-loss event, the transmit state diagram 400 transitions from the start state 402 to state 404. If CH_L_start[SN_R] is not equal to zero, then the transmit state machine 400 transitions to state 410, which is described below. Otherwise, the transmit state machine 400 transitions to state 406.

State 406 initiates an iterative processing loop in which the transmit state machine 400 sequentially increments the local channel number CH_L through the available local transceiver's available transmit channels to attempt to find a channel that is successfully received by the remote transceiver. In particular, in state 406, CH_L is set equal to zero. The transmit state machine 400 then transitions to state 408, where CH_L is incremented by 1.

If CH_L is less than or equal to CH_max, indicating that not all of the available local transmit channels have been tried during the current set of iterations, then the transmit state machine 400 transitions to state 410, where the local transceiver uses the currently selected local transmit channel indicated by CH_L to transmit a CIM message, containing SN_L, CH_L, and CH_R, to the remote transceiver. The transmit function of state 410 is a blocking function, i.e., the transceiver exits state 410 only upon completing the transmission of a properly formatted CIM message. The transmit state machine 400 then transitions to state 412, described further below.

Referring again to state 408, if CH_L exceeds CH_max, indicating that all of the available transmit channels have been tried, then the transmit state machine 400 transitions back to state 406 to initiate another set of iterations through the available transmit channels.

In state 412, the transmit state machine 400 implements a sleep function for duration T2. The sleep function is a blocking function, where the transmit state machine 400 remains in this state for the duration of the time represented by the variable T2, which defines the duration of the inter-CIM time between the end of a current CIM message and the start of the next CIM message. A typical T2 value is preferably shorter than half the duration of the CIM message, which is data-rate dependent. For example, at a bit rate of 500 bps, each CIM message is 320 ms long, with T2 set shorter than 160 ms.

If, during the sleep function of state 412, the local transceiver successfully receives a CIM message from the remote transceiver as part of the execution of the receive state machine 300 of FIG. 3 by the receive process 112, the lock variable will be set to true. When the sleep function is completed after duration T2, if lock is true, then the transmit state machine 400 transitions to state 414, wherein CH_L is set equal to CH_L_start[SN_R], which was set during execution of the receive state machine 300 of FIG. 3. The transmit state machine 300 remains in state 414 until RX_LOSS is greater than T3, indicating that a loss-link event has been detected, in which case, the transmit state machine 300 transitions back to state 410 to transmit another CIM message in an attempt to reacquire communications with the remote transceiver.

Referring again to state 412, if, during the sleep function, the local transceiver does not successfully receive a CIM message from the remote transceiver as part of the execution of the receive state machine 300 of FIG. 3 by the receive process 112, then the lock variable will not have been set to true during that receive process 112. In that case, the transmit state machine 400 transitions back to state 408 to try the next transmit channel in the sequence.

### Channel Information Message (CIM)

FIG. 5 is a diagram representing the format of a CIM message 500, according to certain embodiments of the disclosure. The CIM message 500 of FIG. 5 has the following fields:
SOF: Start of Frame, 8 bits long, representing the maximum frequency transmission pattern of 0x55;
CH_L: Channel Local, 8 bits long, representing the local wavelength channel number. CH_L is expressed in the form of an 8-bit unsigned integer with the valid values in the range of [1;CH_max];
CH_R: Channel Remote, 8 bits long, representing the remote wavelength channel number. CH_R is expressed in the form of an 8-bit unsigned integer with the valid values in the range of [0;CH_max], with the value of “0” representing an unknown/unselected channel;
SN: Serial Number, 16 bytes long, representing the transceiver serial number in ASCII encoding, as specified in INF-8074i for SFP/SFP+, INF-8438 for QSFP, SFF-8436 for QSFP+, SFF-8665 for QSFP28/56, etc. If no serial number is transmitted, then the serial number field is filled with all 0s (NULL characters); and
EOF: End of Frame, 8 bits long, representing a well recognizable pattern of 0xD5, easily distinguishable from the SOF pattern of 0x55.
   Those skilled in the art will understand that other suitable formats for the CIM messages are possible.

Any number of serial-number-specific entries may be stored within a transceiver 110, depending on the memory capacity, implementation choices, etc. Certain implementations may choose to disregard the serial number information and not store any serial-number-specific entries at all, treating each remote transceiver as a new device and not providing any search optimization techniques. When serial-number-specific storage is implemented on the local transceiver, and the remote transceiver does provide its serial number, the local and remote channel numbers are stored and associated with this specific device serial number. The recall of the start local channel number (CH_L_start) is then also implemented based on the serial number of the remote transceiver, speeding up the search process under the assumption that the two transceivers do not frequently change their channel allocation. This assumption is true when, for example, a single client transceiver is moved between different fiber drops/WDM filter ports for testing and validation purposes. The net cost of implementing a serial-number-specific entry mechanism is limited to additional non-volatile memory requirements for the given transceiver, with the size of this non-volatile memory block remaining an implementation choice for a transceiver manufacturer.

The data frame resulting from encoding the CIM message 500 may be Manchester encoded into a frame structure. The Manchester physical coding is specified in IEEE Std 802.3, 7.3.1, the contents of which are incorporated herein by reference in their entirety.

The transmission data rate may be implemented to be variable and depend on the transceiver capabilities. The format of the SOF delimiter and its length is sufficient to synchronize to the incoming data clock and acquire lock before the receipt of the actual data frame. It is recommended that a minimum transmission baud rate of 1000 baud (500 b/s) is used as a default, providing the total CIM transmission time of around 0.3 seconds, resulting in the total sweep time of under 15 seconds for a 40-channel DWDM system. The receive and transmit data paths may operate with different data rates, with the receive data path adjusting its local clock to the received data clock, recovered during the receipt of the SOF pattern.

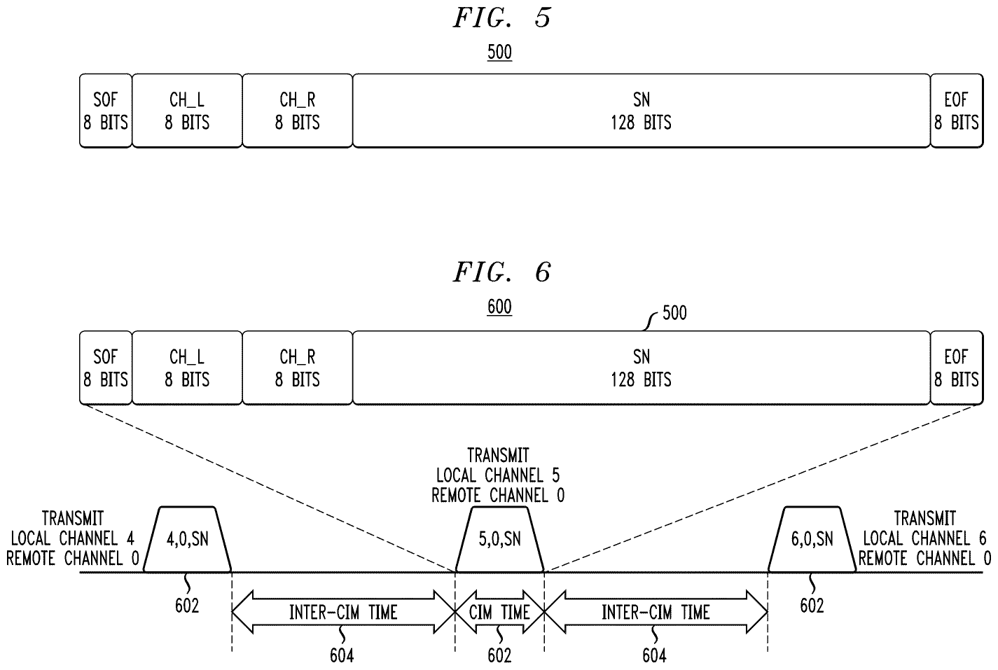

FIG. 6 is a timing diagram 600 illustrating typical connection timing for the network 100 of FIGS. 1 and 2, demonstrating the CIM times 602 (i.e., active data transmissions) as well as inter-CIM times 604 (i.e., idle times, when no data is being transmitted). During each CIM time 602, the whole CIM frame 500 of FIG. 5 is transmitted, starting from SOF, through CH_L, CH_R, SN, and ending with EOF.

FIG. 7 is a timing diagram 700 illustrating an example data exchange between the first and second transceivers 110A and 110B, essentially representing a complete exchange of data between both transceivers, followed by the switch to the regular data transmission (far right side of FIG. 7). Note that FIG. 7 omits the inter-CIM times. The first and second transceivers 110A and 110B both transmit CIM frames 500, using an incrementing channel number approach (an example for simplicity).

In this example, the first transceiver 110A starts by transmitting CIM message (12,0,SN1) in Channel 12, where 0 indicates that the first transceiver 110A has not yet successfully received a CIM message from the second transceiver. Similarly, in parallel, the second transceiver 110B starts by transmitting CIM message (1,0, SN2) in Channel 1.

The second transceiver 110B does not receive the CIM message (12,0, SN1) from the first transceiver 110A. As such, the first transceiver 110A does not receive a CIM message from the second transceiver 110B indicating that the second transceiver 110B received the CIM message (12,0,SN1) from the first transceiver 110A. As such, the first transceiver 110A moves on to the next channel and transmits the CIM message (13,0, SN1) in Channel 13. This processing continues until the first transceiver 110A receives a CIM message from the second transceiver 110B indicating that the second transceiver 110B received a CIM message from the first transceiver 110A.

Similarly, the first transceiver 110A does not receive the CIM message (1,0, SN2) from the second transceiver 110B. As such, the second transceiver 110B does not receive a CIM message from the first transceiver 110A indicating that the first transceiver 110A received the CIM message (1,0, SN2) from the second transceiver 110B. As such, the second transceiver 110B moves on to the next channel and transmits the CIM message (2,0, SN2) in Channel 2. This processing continues until the second transceiver 110B receives a CIM message from the first transceiver 110A indicating that the first transceiver 110A received a CIM message from the second transceiver 110B.

The first transceiver 110A does receive the CIM message (4,0, SN2) from the second transceiver 110B in Channel 4. As such, the first transceiver 110A transmits the next complete CIM message (17,4, SN1) in Channel 17, where the 4 indicates that the first transceiver 110A successfully received a CIM message from the second transceiver 110B in Channel 4. The first transceiver 110A continues to increment its channel and transmit CIM messages indicating Channel 4 as CH_R until the second transceiver 110B successfully receives CIM message (5,4,SN1). In response, the second transceiver 110B transmits its next complete message (4,5,SN2) in Channel 4, where the 5 indicates that the second transceiver 110B successfully received a CIM message from the first transceiver on Channel 5. The first transceiver 110A successfully receives the CIM message (4,5, SN2) from the second transceiver 110B.

At this point, each transceiver (i) has stored information about the proper channel to reach the other transceiver and (ii) has sufficient information to switch to a regular data transmission mode. At this time, both of these transceivers would show up/up state in their respective host devices, enabling the higher-layer transmission to take place. In particular, both transceivers know that (i) the first transceiver 110A should transmit in Channel 5 and (ii) the second transceiver 110B should transmit in Channel 4. As indicated on the right side of FIG. 7, the first transceiver 110A begins transmitting data to the second transceiver 110B using Channel 5, and the second transceiver 110B begins transmitting data to the first transceiver 110A using Channel 4.

Note that, until the second transceiver 110B successfully receives the CIM message (5,4, SN1) from the first transceiver 110A, the second transceiver 110B is not aware that the first transceiver 110A successfully received the CIM message (4,0, SN2) from the second transceiver 110B. As such, the second transceiver 110B continued to increment its transmit channel and transmit corresponding CIM messages until it eventually received the CIM message (5,4, SN1) from the first transceiver 110A.

### Transceiver Register

Given the broad support for optical transceiver formats, the respective transceiver registers defined in the respective Interchange File Format (IFF) specifications need to be augmented to include the following extra bits.
Auto-Tuning Support Flag (read-only) (1 bit): Indicates whether the local transceiver supports the auto-tuning functionality (read/write) (e.g., 0=not supported, 1=supported);
Auto-Tuning Enabled Flag (1 bit): Indicates whether the auto-tuning capability is enabled (e.g., 0=disabled, 1=enabled). This flag is only relevant if the auto-tuning support flag is set (e.g., has the value of 1).
Auto-Tuning Status Flag (read only) (1 bit): Indicates the current status of the auto-tuning process (e.g., 0=tuning, 1=locked)
   The location (device address, page, byte, and bit) is not relevant as long as it is included in the INF information specification for transceiver interoperability.

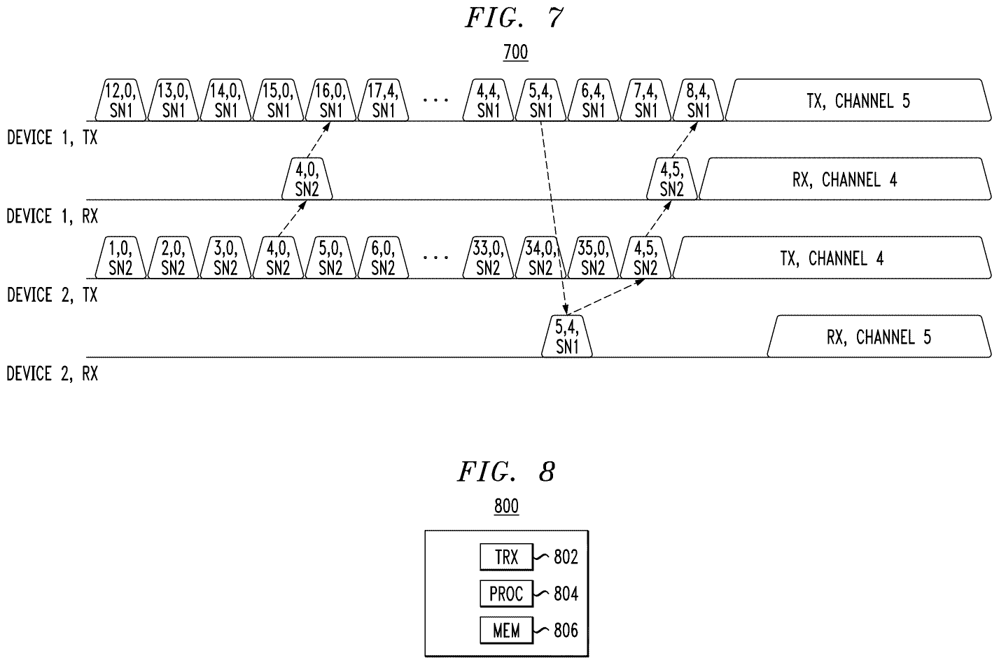

FIG. 8 is a simplified hardware block diagram of an example node 800 that can be used to implement either of the first and second optical transceivers 110A and 110B of FIGS. 1 and 2. As shown in FIG. 8, the node 800 includes (i) communication hardware (e.g., wireless, wireline, and/or optical transmitters and receivers) 802 that supports communications with other optical transceivers and other (e.g., backend) nodes, (ii) one or more processors (e.g., CPU and/or GPU microprocessors) 804 that control the operations of the node 800 and/or process data within the node 800, and (iii) one or more memories (e.g., RAM, ROM) 806 that store code executed by the processors 804 and/or data generated and/or received by the node 800.

In certain embodiments, the present disclosure is a method for a first, auto-tunable, optical transceiver. The first transceiver transmits outgoing Channel Information Messages (CIMs) using a plurality of local channels, each outgoing CIM message identifying (i) the local channel used to transmit the outgoing CIM message and (i) a remote-channel value usable to identify a remote channel used by a second, auto-tunable, optical transceiver to transmit a CIM message to the first transceiver over an optical link, until the first transceiver receives an incoming CIM message from the second transceiver that indicates that the second transceiver received an outgoing CIM message from the first transceiver in a target local channel. The first transceiver transmits data to the second transceiver using the target local channel.

In at least some of the above embodiments, each outgoing CIM message further identifies a serial number of the first transceiver.

In at least some of the above embodiments, the first transceiver selects a sequence of the plurality of local channels for the outgoing CIM messages. After completing the sequence without receiving the incoming CIM message from the second transceiver, the first transceiver restarts the sequence.

In at least some of the above embodiments, the first transceiver implements a transmit process in parallel with a receive process.

In at least some of the above embodiments, in the transmit process, the first transceiver generates and transmits the outgoing CIM messages to the second transceiver and, in the receive process, the first transceiver receives and processes the incoming CIM message from the second transceiver.

In at least some of the above embodiments, the first transceiver stores the target local channel in non-volatile memory; the first transceiver detects whether a link-loss event has occurred; and, when the first transceiver has detected a link-loss event, the first transceiver resumes transmitting outgoing CIM messages starting with the stored target local channel.

In at least some of the above embodiments, the optical link blocks at least some of outgoing CIM messages from reaching the second transceiver, but not an outgoing CIM message in the target local channel.

In at least some of the above embodiments, after receiving the incoming CIM message or another incoming CIM message from the second transceiver, the first transceiver uses the remote-channel value in subsequent outgoing CIM messages transmitted to the second transceiver to identify the channel used by the second transceiver to transmit the incoming CIM message.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of 1 and 2” and “at least one of A or B” are both to be interpreted to have the same meaning, encompassing the following three possibilities: 1—only A; 2—only B; 3—both 1 and 2.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for a first, auto-tunable, optical transceiver, the method comprising the first transceiver:
transmitting outgoing Channel Information Messages (CIMs) using a plurality of local channels, each outgoing CIM message identifying (i) the local channel used to transmit the outgoing CIM message and (i) a remote-channel value usable to identify a remote channel used by a second, auto-tunable, optical transceiver to transmit a CIM message to the first transceiver over an optical link, until the first transceiver receives an incoming CIM message from the second transceiver that indicates that the second transceiver received an outgoing CIM message from the first transceiver in a target local channel; and
transmitting data to the second transceiver using the target local channel.

2. The method of claim 1, wherein each outgoing CIM message further identifies a serial number of the first transceiver.

3. The method of claim 1, wherein:
the first transceiver selects a sequence of the plurality of local channels for the outgoing CIM messages; and
after completing the sequence without receiving the incoming CIM message from the second transceiver, the first transceiver restarts the sequence.

4. The method of claim 1, wherein the first transceiver implements a transmit process in parallel with a receive process.

5. The method of claim 4, wherein:
in the transmit process, the first transceiver generates and transmits the outgoing CIM messages to the second transceiver; and
in the receive process, the first transceiver receives and processes the incoming CIM message from the second transceiver.

6. The method of claim 1, wherein:
the first transceiver stores the target local channel in non-volatile memory;
the first transceiver detects whether a link-loss event has occurred; and
when the first transceiver has detected a link-loss event, the first transceiver resumes transmitting outgoing CIM messages starting with the stored target local channel.

7. The method of claim 1, wherein the optical link blocks at least some of outgoing CIM messages from reaching the second transceiver, but not an outgoing CIM message in the target local channel.

8. The method of claim 1, wherein, after receiving the incoming CIM message or another incoming CIM message from the second transceiver, the first transceiver uses the remote-channel value in subsequent outgoing CIM messages transmitted to the second transceiver to identify the channel used by the second transceiver to transmit the incoming CIM message.

9. A first, auto-tunable, optical transceiver comprising:
a memory; and
at least one processor, coupled to the memory and operative to cause the first transceiver to:
transmit outgoing CIM messages using a plurality of local channels, each outgoing CIM message identifying (i) the local channel used to transmit the outgoing CIM message and (i) a remote-channel value usable to identify a remote channel used by a second, auto-tunable, optical transceiver to transmit a CIM message to the first transceiver over an optical link, until the first transceiver receives an incoming CIM message from the second transceiver that indicates that the second transceiver received an outgoing CIM message from the first transceiver in a target local channel; and
transmit data to the second transceiver using the target local channel.

10. The first transceiver of claim 9, wherein each outgoing CIM message further identifies a serial number of the first transceiver.

11. The first transceiver of claim 9, wherein:
the first transceiver is adapted to select a sequence of the plurality of local channels for the outgoing CIM messages; and
after completing the sequence without receiving the incoming CIM message from the second transceiver, the first transceiver is adapted to restart the sequence.

12. The first transceiver of claim 9, wherein the first transceiver is adapted to implement a transmit process in parallel with a receive process.

13. The first transceiver of claim 12, wherein:
in the transmit process, the first transceiver is adapted to generate and transmit the outgoing CIM messages to the second transceiver; and
in the receive process, the first transceiver is adapted to receive and process the incoming CIM message from the second transceiver.

14. The first transceiver of claim 9, wherein:
the first transceiver is adapted to store the target local channel in non-volatile memory;
the first transceiver is adapted to detect whether a link-loss event has occurred; and
when the first transceiver has detected a link-loss event, the first transceiver is adapted to resume transmitting outgoing CIM messages starting with the stored target local channel.

15. The first transceiver of claim 9, wherein the optical link blocks at least some of outgoing CIM messages from reaching the second transceiver, but not an outgoing CIM message in the target local channel.

16. The first transceiver of claim 9, wherein, after receiving the incoming CIM message or another incoming CIM message from the second transceiver, the first transceiver is adapted to use the remote-channel value in subsequent outgoing CIM messages transmitted to the second transceiver to identify the channel used by the second transceiver to transmit the incoming CIM message.
